(19) United States
(12) Patent Application Publication
(10) Pub. No.: US 2003/0200106 A1
(43) Pub. Date: Oct. 23, 2003

(54) System and method for integrating a virtual letterhead using network-based imaging techniques

(76) Inventors: Shell Sterling Simpson, Boise, ID (US); Ward Scott Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/127,320

(22) Filed: Apr. 22, 2002

(51) Int. Cl. G06F 17/00; G07B 17/02; G06F 17/60

(52) U.S. Cl. 705/1

(57) ABSTRACT

An improved system and method for integrating a letterhead to a document are disclosed. The system may comprise a server and a computing device coupled to each other via a network. In preferred embodiments, a selected virtual-letterhead composition is associated with a target composition, forming a modified target composition. The modified target composition comprises the necessary information for a device to acquire and construct a desired integration of the virtual-letterhead composition with the target composition. A method for integrating a virtual-letterhead composition with a printing device, can be summarized by the following steps: accessing a print service; identifying a print device in communication with the print service; receiving at least one virtual-letterhead composition from a network-connected device; and selecting the at least one virtual-letterhead composition as a media type

### TECHNICAL FIELD

The present disclosure relates to systems and methods for processing digital representations of images. More particularly, the invention relates to systems and methods for integrating a virtual letterhead with an image.

### BACKGROUND OF THE INVENTION

Letterhead is a term commonly used to describe a sheet of stationery, printed or engraved, usually with the name and address of an organization or other entity. Consequently, letterhead is a mechanism for identifying the source of printed correspondence. Before the introduction of computer-controlled printing devices, letterhead was often produced and delivered by a printing service. Each letter, report, or other correspondence produced by an organization that used this pre-printed letterhead had to coordinate its production, supply, storage, and distribution throughout the organization.

The recent proliferation of relatively low-cost high-quality printing devices coupled with advances in word-processing technology has made it possible to produce letterhead templates in the form of document files that can be used along with a printing device to generate a physical letterhead. This self-generated letterhead can in turn be used to supply an input paper tray of a printer or copier. Alternatively, the electronic version of the letterhead template can be used as a starting point for correspondence designated for integration with the information in the letterhead template.

Despite these and other recent advances, such as the introduction of multiple-source printing devices, the use of letterhead is still problematic. For example, in those cases where an organization uses pre-printed letterhead, human resources within the organization must still be expended ordering, receiving, storing, distributing, and supplying the various offices and printer supply trays across the organization with the correct pre-printed letterhead. These problems may grow geometrically if various offices and departments within an organization are using “customized” letterhead designs and/or using multiple letterhead designs over different pages of their correspondence.

Word processing and desktop publishing software applications require printer drivers in order to support the completion of a particular hard-copy generation task (i.e, a request to print a document file). A driver is a computer program that controls a device. Peripheral devices associated with computers, whether printers, disk drives, keyboards, pointing devices, and the like, are supported by a driver. Many drivers, such as keyboard, disk drive, and pointing device drivers, are supplied with the operating system. For other devices, a driver program may have to be loaded before the associated peripheral device will operate with the computer.

A driver acts like a language translator between the peripheral device and programs that use the device. Each peripheral device has its own set of specialized commands that only its driver knows. In contrast, most application programs access devices using generic commands. The driver, therefore, accepts generic commands from an application program operating on the computer and translates the commands into the specialized commands for the particular peripheral device.

Often a printer driver that supports language translation between a particular application and a particular printer model does not even exist. In cases where a printer driver has been created for use with a particular printer model, the driver must be located and installed. Even when they exist, conventional printer drivers have a number of limitations. First, the drivers must be located and installed. Second, conventional drivers do not include the capability to define a letterhead template for use across multiple printers.

Because printer drivers as explained above are generated for each particular type of printer, a letterhead template that has been added or defined for use with a first printer is not automatically usable with another printer. Stated another way, an operator of a computing system that desires to integrate a particular letterhead template with multiple printers must recreate the letterhead template for each printer. Third, conventional printers and their drivers do not support a true “preview” of the expected results. Because typical printer-driver user interfaces do not include the capability to retrieve an actual data document while integrating a letterhead template, a “preview” step generally results in a rendition of the location, color, and brightness of the letterhead information on a blank page. Only after a user of the software selects the “print” option is the data file acquired by the driver and forwarded by the driver to the printing device. At the time the data file is acquired by the driver, printing has already been initiated.

Word processors also do not provide an easy solution for merging a letterhead template with previously generated correspondence data. In order to create a final product, operators of conventional word processors generally may open a first file containing the letterhead template, then open a second file containing the correspondence data Next, the operator may select that portion of the correspondence data that is designated for integration with the letterhead information. Last, the operator may cut and paste the selected correspondence data in the appropriate location of the letterhead document in order to produce the desired final product.

Letterhead can also be integrated with the contents of a document file using various commercially available desktop publishing application programs For example, Fineprint by FinePrint Software, LLC (http://www.fineprint.com/) of San Francisco, Calif., provides an interface wherein a user of the application can generate and store an electronic version of a letterhead. The FinePrint application also permits the user to define one or more letterheads and subsequently permits the user to select a previously defined letterhead document by name. Once a letterhead document has been defined by the user, the FinePrint “capture” function may be used to deliver the data intended for integration with the defined letterhead document to the FinePrint application. The FinePrint application then provides a pseudo preview of the data selected for the print job together with the selected letterhead document as explained above. However, the pseudo preview does not account for specific characteristics (e g, paper type) of the destination printer. This can be particularly problematic when the selected paper is pre-punched and information from either the letterhead document or the data selected for the print job is co-located with one of the pre-punched holes.

Thus, conventional software applications require installation of the application software, installation of specialized drivers, and multiple user intervention steps to integrate, preview, and generate a hard-copy product with a letterhead.

Despite the capabilities now available via printer drivers and software applications to add letterhead information to a hard-copy rendition of an image (i e, a document), improved systems and methods for seamlessly integrating a letterhead with an image file are desired.

### SUMMARY OF THE INVENTION

Systems and methods for integrating a virtual letterhead with an image using network-based imaging techniques are disclosed. Briefly described, in architecture, a network-based imaging system can be realized with a server, a computing device, and a network infrastructure communicatively coupling the server with the computing device.

In some embodiments, a network-coupled imaging service offers a mechanism for generating a letterhead template. The letterhead template may be stored on various devices coupled to the network. The letterhead template may also be stored as a virtual-letterhead composition (i e, a compilation of one or more images) for subsequent uses.

In those embodiments where the letterhead template has been stored as a virtual-letterhead composition, the virtual-letterhead composition can be integrated within a network-connected printing device. In these embodiments, the virtual-letterhead composition can be presented by a printing device interface as a selectable paper or media type that may look like a selectable paper type to a user of the system. Because the virtual-letterhead composition is available, the network-connected printing device can present a true “pre-view” of the contents of the virtual letterhead in register with the contents of a document image and the selected print media.

In other embodiments, a user may be associated with a personalized letterhead service. In these embodiments, the letterhead may be stored and accessed from the user's personal-imaging repository (e g, a network-coupled data storage device). This allows the user to browse around the network and instantly have available to them a “personalized” letterhead.

Some embodiments of the system can be viewed as providing methods for generating a virtual letterhead. An exemplar method can be described by the following steps: accessing a letterhead service; selecting a letterhead template from the letterhead service, and generating a virtual-letterhead composition containing images reflective of underlying information associated with the letterhead template.

Other embodiments of the invention can be viewed as methods for integrating a virtual letterhead. An exemplar method includes the following steps: generating a letterhead template; using at least one image from the letterhead template to form a virtual-letterhead composition; storing the virtual-letterhead composition; and implementing a mechanism that permits access to the stored virtual-letterhead composition to network-connected devices.

Alternative embodiments of the invention can be viewed as methods for integrating a virtual letterhead as a media source in a printing device In this regard, an exemplar method includes the following steps: selecting a letterhead template; identifying a desired printing device; generating a virtual-letterhead composition; inserting the virtual-letterhead composition as a media type associated with the desired printing device; and layering the virtual-letterhead composition with source data

### BRIEF DESCRIPTION OF THE DRAWINGS

The systems and methods for integrating virtual letterhead(s) can be better understood with reference to the following drawings. The components in the drawings are not necessarily to scale emphasis instead is placed upon clearly illustrating the principles of integrating virtual letterhead(s). Furthermore, in the drawings, like reference numerals designate corresponding parts throughout the several views.

FIG. 1 is a schematic illustrating the general operation of an embodiment of an exemplar solution for integrating virtual letterhead(s) with document compositions.

FIG. 2 is a schematic diagram illustrating an embodiment of a distributed system in which the solution of FIG. I may be realized.

FIG. 3 is an embodiment of a network-based imaging system in which the system and method for integrating virtual letterhead(s) with document compositions of FIG. 1 may be realized.

FIG. 4 is a second embodiment of a network-based imaging system in which the system and method for integrating virtual letterhead(s) with document compositions of FIG. 1.

FIG. 5 is an embodiment of the imaging-client device shown in FIGS. 3 and 4.

FIG. 6 is a schematic diagram illustrating an embodiment of an exemplar network-based imaging system.

FIG. 7 is a flowchart illustrating a method for generating virtual-letterhead compositions that may be used in the network-based imaging system of FIG. 6.

FIG. 8 is a flowchart illustrating a method for integrating virtual-letterhead compositions with a network-connected printing device that may be realized in the network-based imaging system of FIG. 6.

FIG. 9 is a schematic diagram illustrating an embodiment of the network-based imaging system of FIG. 6.

### DETAILED DESCRIPTION

As described above and as will be further detailed below, a letterhead is a humanly observable image containing text and graphics (e.g., a logo), which can be layered upon one or more pages of a letter or other correspondence. Generally, the information within the letterhead contains one or more identifiers commonly associated with the party or organization that generated the correspondence. These identifiers may include the name and address of an organization, as well as the name, office, and contact information of the individual that authored the message in the correspondence along with other information. Typically, the letterhead information is added or layered on top of the first page of a composition (i.e., the target or primary image may be applied after the letterhead has been applied to the physical medium). The same, or other, letterhead images can be applied to the remaining pages of the target or primary image in any other arrangement as may be desired.

Various aspects of the system and method for integrating virtual-letterhead compositions using network-based imaging solutions, having been summarized above, reference will now be made in detail to the description of the exemplar systems and methods illustrated in the drawings. While the systems and methods for integrating virtual-letterhead compositions will be described in connection with these drawings, there is no intent to limit it to the embodiment or embodiments disclosed therein. On the contrary, the intent is to cover all alternatives, modifications, and equivalents included within the scope of the systems and methods for integrating virtual-letterhead compositions using network-based imaging solutions as defined by the appended claims.

Generally, the system has a distributed architecture with which a user can maintain data in a personal-imaging repository Various network-coupled services, including services that generate and store and/or simply store virtual-letterhead template information (i e., a collection of text and graphic images), among other services, may controllably provide data to, or alternatively accept data from, one or more users to compose and/or select a letterhead template. A letterhead template includes that information necessary to formulate a representation of the desired letterhead image.

Target or primary images contain information such as the contents of a letter or other correspondence that a user of the system desires to integrate with the information in the letterhead template to form a product. Target images may be stored in a user's personal-imaging repository. Target images may be accessed by a composition that provides access to one or more services interested in using the graphics data identified by the composition. A destination service in the system accesses imaging information available through a user's personal-imaging repository. Conversely, a source service in the system contributes information to a user's personal-imaging repository. This imaging information can be accessed and/or provided in a variety of forms because the imaging information is accessed through a collection of methods (i e, a programmatic interface) that enables a node in the system (i.e., a personal-imaging repository, a destination service, a source service, and/or a service that acts as both a destination and a source service, among others) to negotiate the preferred form(s) in which it wishes to transfer data. A system node can be a computing device or some other device, such as a router, a printer, a scanner, among others, communicatively coupled with the network. Each node has a unique network address sometimes called a data-link control (DLC) address or a media-access control (MAC) address.

In preferred arrangements, the user identifies and accesses a network-based or web-based imaging service that enables the user to access the imaging data in the user's personal-imaging repository (i e, a target image file), as well as arrange the imaging data as desired. An imaging-source service does not necessarily have to access a personal-imaging repository before contributing imaging information (including the arrangement of imaging information, which, in a sense, is just another kind of imaging information) to the user's personal-imaging repository. An imaging-source service generates imaging data that is added to the users personal-imaging repository. This can be accomplished by the user inputting data, the user arranging existing data already in their personal-imaging repository, as well as by other methods. Thus, “imaging data” is associated with the user in question, so that imaging-destination services can subsequently use user specific data. Thereafter, as desired, a network-based imaging server can be accessed to formulate and/or retrieve a desired virtual-letterhead composition for integration with one or more target images stored in the user's personal-imaging repository or within an imaging-client device.

The imaging service may be realized on a local node (i e, a local area network connected device) or a remote node (i.e, a wide area network connected device) in the system. In some embodiments, the imaging service may be integrated with a print service or other publishing service. As in the case of the imaging service, the print service may also be realized on local node or a remote node in the system. In alternative embodiments, an imaging service may be embedded within a print device, an image-acquisition device, such as a digital camera, a digital-video camera, a scanner, among others, or may operate on a server separate and distinct from the print device. It should be appreciated that in the case where the print service is remotely located, the user may be interfacing with a third-party operated service that may provide network-based printing services in exchange for payment of a fee.

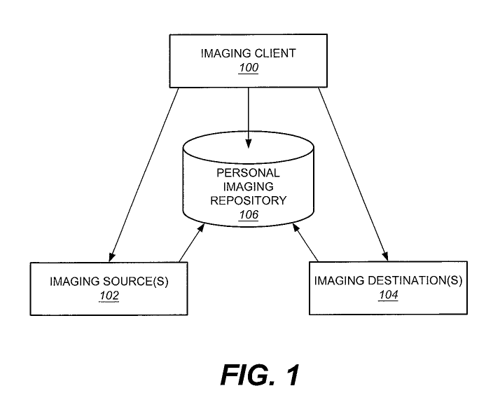

FIG. 1 is a schematic representation of the general operation of the systems and methods for integrating virtual letterhead(s). As shown in this figure, an imaging client 100 communicates with one or more imaging sources 102, one or more imaging destinations 104, and a personal-imaging repository 106. The imaging source(s) 102 represent any of a variety of devices/services that can be accessed by the imaging client 100 and used to select or identify imaging data that may be integrated as a letterhead with a previously stored target image (e.g., a text document, a photo, a map, or other images).

The personal-imaging repository 106 provides image-storage facilities that typically are personalized for the individual imaging client 100 The imaging repository 106 can be located in various places. For example, the repository 106 can be maintained on one or more computing devices associated with the imaging client 100, imaging source(s) 102, or imaging destination(s) 104. Alternatively, the repository 106 can be maintained on a separate computing device (e.g., a file server) that the imaging client 100, imaging source(s) 102, and imaging destination(s) 104 can access. The data in the imaging repository 106 can be any type of image or graphics-based data, such as text images, video frames, animations, photographs, and/or combinations thereof.

Once data is stored in the personal-imaging repository 106, the imaging client 100 can select data from the repository that is intended to be communicated to the imaging destination(s) 104 for some form of processing or manipulation. By way of example, the data may be transmitted to the image destination(s) 104 for printing. In preferred embodiments, the data may include a composition or a set of graphics identifying both a virtual-letterhead composition and one or more target images. Where the imaging destination(s) 104 are adapted for printing, they may comprise any of a wide variety of printing devices that are capable of generating hard-copy products, such as printers, multi-function peripherals (MFPs), plotters, services managing printing devices, and others.

As will be apparent from the discussions that follow, the above-described manner of operation provides a high degree of personalization to the imaging client 100 Specifically, in that the client's personal information can be accessed and utilized with any participating service (e.g., web site) accessible by the client, each accessible service can be “customized” based on the underlying data for each particular user.

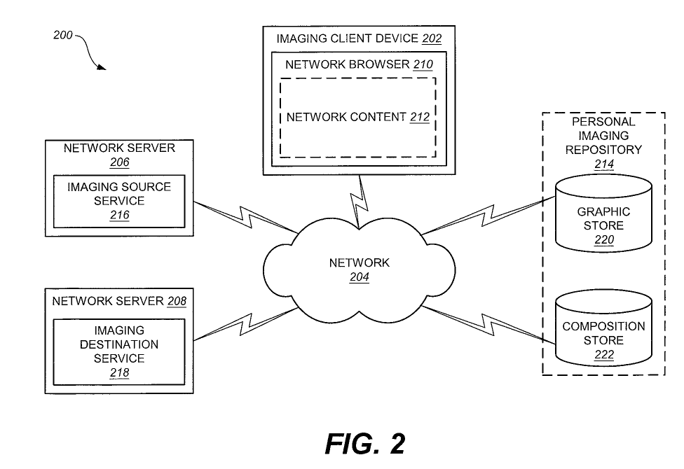

FIG. 2 illustrates an exemplar-distributed system 200 in which the systems and methods for integrating virtual letterhead(s) can be implemented As indicated in FIG. 2, the system 200 includes an imaging-client device 202 that is coupled to a network 204. Through this coupling, the imaging-client device 202, and therefore the imaging client (i.e., a user), can be placed in communication with one or more network servers, such as servers 206 and 208. The imaging-client device 202 and network servers 206 and 208 represent any of a wide variety of wired and/or wireless computing devices, such as desktop computers, portable computers, dedicated server computers, multi-processor computing devices, personal-digital assistants (PDAs), mobile telephones, pen-based computers, gaming consoles, and so forth.

The network 204 represents one or more data distribution networks that can be used to communicate data and other information (e g, control information) between or among various computing devices. Examples for the network 204 include the publicly accessible wide area network (WAN) commonly known as the Internet, a local area network (LAN), other public and/or private WANs, and combinations thereof. The network 204 can further include various different types of networks, including wired and/or wireless portions, employing any of a variety of different communications protocols including public and/or proprietary communications protocols.

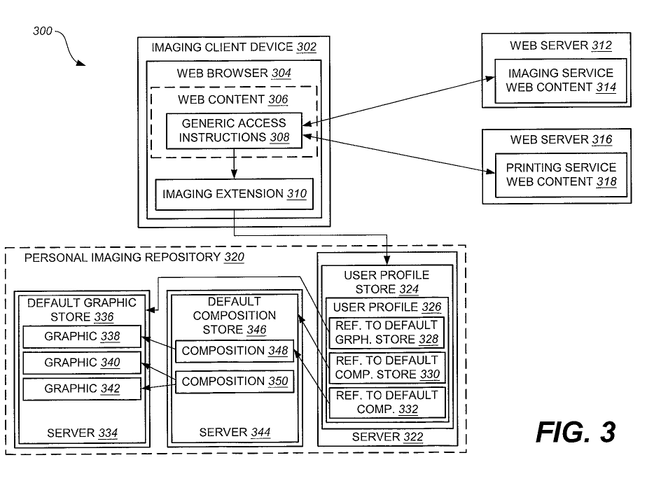

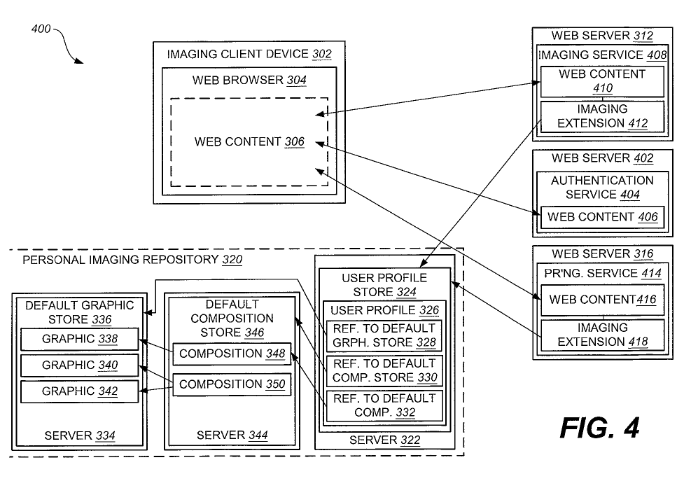

During operation, the user can operate a network browser 210 executing on the imaging-client device 202 to interact with imaging services 216, 218 executing on the network servers 206 and 208, respectively. As used herein, the term “services” refers to software and/or firmware components that can execute on one or more computing devices and which provide one or more particular functions to the imaging-client device 202, such as imaging data selection and arrangement, data manipulation (including integration of a virtual-letterhead composition), printing, and others. As indicated in FIG. 2, the network browser 210 can receive network content 212 from one or more of the network servers 206 and 208. This content 212 may include various components such as, for example, text, graphics, commands (e.g, hypertext mark-up language (HTML), Java™, JavaScript™, etc) and/or applications (e g, Java™ applets). In use, the content 212 in some arrangements may facilitate communication with a personal-imaging repository 214 so that the servers 206 and 208 can access data stored in the personal-imaging repository 214. Examples of the ways in which this communication can be facilitated are described below with reference to FIGS. 3 and 4.

The network server 206 executes an imaging-source service 216 that, among other things, allows the user to interact with his or her personal-imaging repository 214. The imaging-source service 216 may actually provide multiple services that can be accessed by the user. In some embodiments, these services can provide different functions to the user. For instance, one service may be responsible for graphic storage and retrieval while another service may be responsible for merging graphics in a single document By accessing these services with the network browser 210, the user can select or identify imaging data that are to be stored as graphics in a graphic store 220 of the personal-imaging repository 214. These graphics can be stored as individual files and generally can comprise any data capable of representation as a two-dimensional graphic. As discussed below, the individual graphics in store 220 can be used as individual images that can be printed or otherwise reproduced on appropriate media, or multiple individual graphics can be compiled together as a single image for printing and/or other methods of generating a hard-copy output.

Irrespective of whether multiple graphics are to be used, the imaging-source service 216 can be used to arrange the graphic(s) on a visual representation of a document to be created. Once the arrangement has been selected, the imaging-source service 216 can store the arrangement as a composition (i e, a collection of images) in a composition store 222 of the personal image repository 214. It is to be noted that, although the graphic store 220 and the composition store 222 are illustrated as two separate stores, multiple stores may exist in the system 200 and one or more graphic stores 220 may be combined with one or more composition stores 222 as desired. Additionally, one or more of these stores 220 and 222 may be implemented on the imaging-client device 202, one or more of the servers 206 or 208, or on other designated computing devices (not shown).

Once the graphics and composition have been selected, the image data can be processed or otherwise manipulated by accessing an imaging-destination service 218 that executes on the network server 208. Where one or more hard-copy products are to be generated, this service 218 can comprise a print service with which document(s) can be printed and/or other hard-copy products may be generated. In one such scenario, a print request is communicated to the imaging-destination service 218 and, upon receipt of the print request, the network server 208 interacts with the graphic store 220 and composition store 222 to retrieve the data needed to complete the print job. Once the data are retrieved, the network server 208 interacts with one or more printing devices (not shown) to which the server is coupled (directly or indirectly) to generate the hard-copy document(s).

FIG. 3 illustrates a first exemplar network-based imaging system 300 in which the systems and methods for integrating virtual letterhead(s) can be implemented. As will be appreciated from the discussion that follows, this system 300 can be described as a client-based implementation in that much of the system functionality is provided by a client device. A similar system is described in detail in U.S. patent application Ser. No. ______, entitled “A Method, System and Program Product for Multi-Profile Operations and Expansive Profile Operation,” by Shell Simpson, Ward Foster, and Kris Livingston and bearing Attorney Docket No. 10007690-1, the disclosure of which is hereby incorporated by reference in its entirety into the present disclosure.

As indicated in FIG. 3, the system 300 includes an imaging-client device 302. The imaging-client device 302 comprises a web browser 304 that is adapted to access web content 306 derived from imaging service web content 314 and printing-service web content 318 of web servers 312 and 316, respectively. Web browsers 304 are programs running on client computers (e.g., imaging-client device 302) that execute web content 306. A web browser 304 requests web content 306 using the hypertext transfer protocol (HTTP). HTTP is a protocol used to transfer web content 306. For data transfers under HTTP, the client (a web browser 304) connects to a server (the web server 312, 316) and requests a specific document using a “GET” command. The GET command allows the client to specify the uniform resource locator (URL) of the desired web page.

In contrast with the client-side execution described above, server-side execution can be implemented by scripts and/or other programs that are executed on the web server 312, 316 for the purpose of generating an appropriate response to a HTTP “GET” command. Server-side execution can be accomplished using a variety of technologies including an application service provider (ASP), a personal home page (PHP) hypertext preprocessor (a server-side scripting language), servelets, etc.

Web servers 312, 316 are programs running on server computers that deliver web content 306 to web browsers 304 when web browsers 304 request web content 306 The web content 306 may already exist, such as a file on disk, or may be generated dynamically based on various data supplied from the web browser 304.

The web content 306, like content 212, typically comprises text, graphics, and various commands. The commands can comprise one or more sets of executable instructions that are downloaded (i e., communicated) to the web browser 304 to perform a service requested by the user. These instructions can be written in any suitable language including, for instance, HTML, Java™, JavaScript™, C-sharp, or other appropriate languages. A variety of different functions can be served by the executable instructions. For example, the web content 306 normally includes executable instructions for causing graphics, i e graphics provided by an accessed web site, such as, but not limited to a virtual-letterhead composition, to be displayed on an input/output device, such as a display monitor in association with the imaging-client device 302.

In the embodiment shown in FIG. 3, the executable instructions are further used to access a personal-imaging repository 320. These instructions typically comprise system-wide generic-access instructions 308 that call on an imaging extension 310 to access the personal-imaging repository 320 and perform various web-imaging operations. These instructions 308 are designated as “generic” because they are independent of the configuration of the user's personal-imaging repository 320. As discussed in greater detail below, the generic-access instructions 308 can be used to, for example, add a graphic, such as a virtual-letterhead composition, to a default-graphic store 336 of the personal-imaging repository 320, or add a new composition to a default-composition store 346 of the personal-imaging repository 320.

As is further indicated in FIG. 3, the imaging extension 310 can form part of the web browser 304. Although this arrangement is shown in the figure and described herein, the imaging extension 310 can, alternatively, be provided outside of the web browser 304, for instance on a different device. Irrespective of its location, however, the imaging extension 310 is configured to respond to the execution of the generic-access instructions 308 by generating and/or mapping corresponding imaging-client specific commands entered by the user. The imaging extension 310 typically is implemented as one or more application programming instructions (APIs) that, preferably, act as interfaces in accordance with a system-wide standard.

When executed, the generic-access instructions 308 cause imaging extension calls (e g, API calls) to be issued, which in turn, cause the imaging extension 310 (e.g, APIs) to access the user's personal-imaging repository 320. The web content 306 therefore uses the imaging extension 310 as a gateway to access the user's personal-imaging repository 320 Generally, the APIs can comprise sets of methods for establishing a destination for redirecting the web browser 304 based on some form of received redirection initiation. In such circumstances, the process normally comprises receiving a redirection initiation to redirect the web browser 304, retrieving a direct or indirect reference to a destination, and then causing the web browser 304 to extract information from that particular destination. It will be recognized that there are many other ways (both in hardware and software) to implement this function.

In some arrangements, the imaging extension 310 is configured to prevent the web content 306 (i.e, the executable instructions from one or more web services), from arbitrarily accessing the user's personal-imaging repository 320. This restricted access can be imposed upon the web content 306 using a variety of methods. For example, an imaging extension API can be configured to only accept references from the web content 306 that were previously provided by the imaging extension 310. In such a scenario, the content 306 cannot arbitrarily supply references when calling the imaging extension API. Therefore, in order to access the user's personal-imaging repository 320, the web content 306 must first obtain references using the imaging extension API.

The imaging extension 310 can be used to access one or more user profiles 326 that is/are stored in a user-profile store 324 of a server 322 of the personal-imaging repository 320. By way of example, the imaging extension 310 can be directed to the user profile 326 with a uniform resource locator (URL), pointer, socket, or other detail. In some embodiments, the same user can have multiple user profiles. This may be particularly advantageous when a firewall (not shown) is encountered When firewalls are encountered, different graphic stores and composition stores can be accessed depending on the location of the firewall in relation to the various stores and a communicating node.

The user profile 326 typically includes references to all or a portion of the personal-imaging repository 320 for that user profile. For instance, as shown in FIG. 3, the user profile 326 can include a reference 328 to a default-graphic store, a reference 330 to a default-composition store, and a reference 332 to a default composition. In use, the user-profile store 324 functions as a service that uses appropriate methods to create, modify, access, and cancel profiles. Accordingly, the imaging extension 310 maps to the appropriate methods (i e., makes use of the methods) in the user profile 326 to obtain the reference to various repository items such as the default-graphic store 336 and the default-composition store 346.

Like the user-profile store 324, the default-graphic store 336 and default-composition store 346 can reside on separate servers 334 and 344. It will be understood, however, that one or more of the stores could reside on a single machine, if desired As indicated in FIG. 3, the default-graphic store 336 is used to store various graphics, such as graphics 338, 340, and 342. These graphics can be stored in substantially any format. For example, these formats (i.e., file extensions) can comprise PDF, JPEG, PostScript, TIFF, GIF, BMP, etc. In addition, the default-graphic store 336 can include a programming interface consisting of a number of methods. Because the default-graphic store 336 is implemented as a network service, these methods would be accessible through some sort of remote-invocation technology such as a remote-procedure call (RPC), a simple-object access protocol (SOAP), a common-object request-broker architecture (CORBA), a distributed-component object model (DCOM), or others. Therefore, in contrast to merely providing for graphic storage, the graphic store 336 can also provide services used to create, retrieve, and/or manipulate graphics. These services may include a user interface for integrating various images as virtual-letterhead compositions with target images stored within the graphics store 336. Furthermore, the default-graphic store 336 can communicate with the web content of various web services. For example, printing-service web content 318 can submit queries to the default-graphic store 336 (via the extension 310) about a print job, as well as request that one or more graphics be transmitted in a desired arrangement to optimize printing performance. In some circumstances, the request may include a request for a virtual-letterhead composition (i e, a collection of images) as well as a target image.

The default-composition store 346 stores various compositions, such as compositions, 348 and 350, which can be used to arrange the selected graphics. Like the user-profile store 324 and default-graphic store 336, the default-composition store 346 can also comprise various programming interfaces consisting of a number of methods that can be used to access graphics from the graphic store, manipulate the graphics, etc.

FIG. 4 illustrates a second exemplar network-based imaging system 400 in which the systems and methods for integrating virtual letterhead(s) can be realized. As indicated in FIG. 4, the system 400 includes many of the features of the system 300 shown in FIG. 3. Therefore, the system 400 includes an imaging-client device 302 that executes a web browser 304 to receive web content 306. The system 400 also includes a personal-imaging repository 320 that for example, can include a user-profile store 324, a default-graphic store 336, and a default-composition store 346. Furthermore, the system 400 includes web servers 312 and 316. Each of these components is generally configured in a similar manner as the like-named and numbered features identified in FIG. 3. However, unlike the client-based system 300, the system 400 provides a server-based implementation in which many of the functions provided by the client device 302 in the system 300 are transferred to another device. By way of example, this other device can comprise a further web server 402, which executes an authentication service 404. As shown in FIG. 4, the authentication service 404 comprises web content 406 that can be downloaded into the user's browser 304.

In addition to the above-noted differences, the servers 312 and 316 are provided with different software in the system 400 to permit alternative modes of operation. By way of example, the web server 312 can execute an imaging service 408, which includes web content 410 and an imaging extension 412. Similarly, the web server 316 can execute a printing service 414 that includes web content 416 and an imaging extension 418. Like the web content 314 and 318 of the system 300, the web content 410 and web content 416 typically comprise text and graphics that can be downloaded into the user's browser 304. Unlike the system 300, however, generic-access instructions need not be downloaded into the browser 304 in that the browser does not comprise its own imaging extension. Such an arrangement is advantageous where the imaging-client device 302 has limited storage capacity (e g, for PDAs, mobile telephones and other similar devices). Instead, as identified above, the services 408 and 414 include their own imaging extensions 412 and 418, respectively, that can be used to access the user's personal-imaging repository 320. By way of example, the web content 410 and 416 comprise server-side code including one or more of personal-home page (PHP) or personal-home page hypertext-preprocessor scripts, Java™ Servlets, Java™ server pages (JSPs), active-server pages (ASPs), etc.

Each of the imaging extensions 412 and 418 typically has configurations that are similar to that of the imaging extension 310 (FIG. 3). Therefore, the imaging extensions 412 and 418 can comprise one or more programmatic interfaces that include one or more methods that, when invoked, access the user's personal-imaging repository 320. Again, the programmatic interfaces can comprise sets of methods for establishing a destination for redirecting the browser 304 based on some form of received redirection initiation. The programmatic interface can include methods that return or make use of, for instance, a URL, pointer, socket, or other detail to facilitate the redirection.

The manner in which the personal-imaging repository 320 is accessed by the services in the system 400 will now be discussed with reference to an exemplar scenario In this example, the user browses to the imaging service 408 using the web browser 304 of the imaging-client device 302. Upon reaching the service 408, web content 410 is executed to generate web pages that are downloaded to the web browser 304 (as content 306).

For the purposes of this application, a web page refers both to data that is executed within the web server to generate data to be downloaded to the browser, as well as data that is downloaded to and executes within the browser. Presently, the art fails to distinguish between different stages of web page generation. The terms “server-side” and “client-side,” however, are often used to distinguish where web page related execution occurs. Once the content 306 is received, the browser 304 is redirected by the content 306 to the authentication service 404 that resides on the web server 402. Typically, this is accomplished by the web content 410 through the creation of a HTTP redirect that when downloaded to the browser 304, causes the browser to redirect to an address (e g, URL) identified in the header entry. Web content 410 is then downloaded to the web browser 304 and the user is provided with an opportunity to complete an authentication procedure that identifies both the user's identity and the location of the user's personal-imaging repository 320.

The authentication procedure can, for example, comprise entry of authentication information, such a user name and password that have been registered with the authentication service 404, for example, in a previous session. This information can be entered in a web page generated by the web server 402. In an alternative arrangement, the authentication procedure can comprise the reading of a user identification card, which includes storage media (e.g., magnetic strip) that contains the user's authentication information. Persons having ordinary skill in the art will recognize that many other authentication alternatives exist that may be integrated with the systems and methods for integrating virtual letterhead(s).

Once the user successfully completes the authentication procedure, the browser 304 is again redirected, this time back to the imaging service 408. The redirection address (e.g., URL) directs the web browser 304 back to the imaging service 408 and may contain information that identifies the user and the user's personal-imaging repository 320 (e.g, with a further URL). To avoid continual redirection back and forth, a “cookie” can be stored on the imaging-client device 302 that permits the authentication service 404 to validate the user's identity without requiring a further log in. Note that the use of a “cookie” by the authentication service does not eliminate redirection between the imaging service and an authentication service. Such a “cookie” merely eliminates the need to query the user for identification information. A “cookie” could be used by the imaging service to avoid redirection to the authentication services Once the user's identity information is possessed by the imaging service 408, the service can, when appropriate, make calls to its imaging extension 412 (e.g, programmatic interface calls) to command the imaging extension to access the user-profile store 324 of the personal-imaging repository 320. Through this access, the imaging service 408 can be used by the user to, for instance, select or identify imaging data to be stored as graphics in the default-graphic store 336.

When the printing service 414 is accessed, for example through redirection from the imaging service 408 as when a “print” button is selected, various content is downloaded to the web browser 304. The printing service 414 can then access the default-graphic store 336 and default-composition store 346 such that the graphics to be printed can be accessed and an intended arrangement of the document obtained. Although the default-graphic store 336 and default-composition store 346 may be accessed, typically a destination service such as printing service 414 accesses the default composition from the user profile. The default composition determines which graphics are accessed. The default composition may or may not refer to a composition that is located in the default-composition store 346.

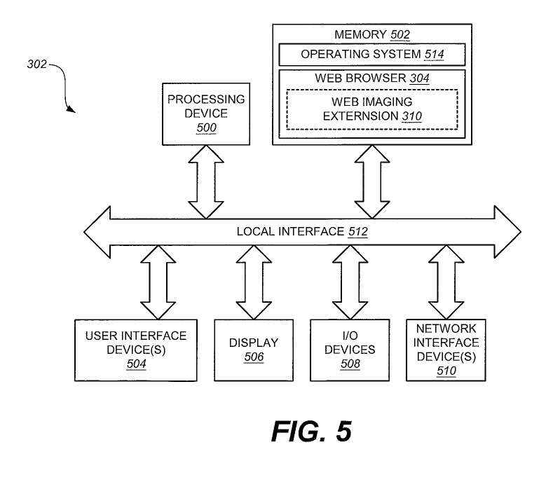

Reference is now directed to FIG. 5, which presents a schematic view illustrating an exemplar architecture of the imaging-client device 302 introduced in FIGS. 3 and 4. As identified above, the client device 302 can be any one of a variety of computing devices, such as desktop computers, portable computers, dedicated server computers, multi-processor computing devices, cellular telephones, PDAs, handheld or pen-based computers, gaming consoles, and others. Irrespective of its type, the client device 302 typically comprises a processing device 500, memory 502, one or more user interface devices 504, a display 506, one or more input/output (I/O) devices 508, and one or more network interface devices 510, each of which is connected to a local interface 512.

The local interface 512 can be, but is not limited to, one or more buses or other wired or wireless connections as is known in the art. The local interface 512 may have additional elements, such as buffers (caches), drivers, and controllers (omitted here for simplicity), to enable communications Further, the local interface 512 includes address, control, and data connections to enable appropriate communications among the aforementioned components.

The processing device 500 can include any custom made or commercially available processor, a central processing unit (CPU) or an auxiliary processor among several processors associated with the client device 302, a semiconductor based microprocessor (in the form of a microchip), a macro-processor, one or more application-specific integrated circuits (ASICs), a plurality of suitably configured digital-logic gates, and other well known electrical configurations comprising discrete elements both individually and in various combinations to coordinate the overall operation of the imaging-client device 302. The memory 502 can include any one of a combination of volatile-memory elements (e g., random-access memory (RAM, such as DRAM, SRAM, etc.)) and nonvolatile-memory elements (e.g, ROM, hard drive, tape, CD-ROM, etc.).

The one or more user-interface devices 504 comprise those components with which the user can interact with the imaging-client device 302. For example, where the imaging-client device 302 comprises a personal computer (PC), these components can comprise a keyboard, a mouse, a joystick, etc. Where the imaging-client device 302 comprises a handheld device (e g, PDA, mobile telephone), these components can comprise function keys or buttons, a touch-sensitive screen, a stylus, etc. The display 506 can comprise a computer monitor or plasma screen for a PC or a liquid crystal display (LCD) for a handheld device.

With further reference to FIG. 5, the one or more I/O devices 508 are adapted to facilitate connection of the client device 302 to another device and may therefore include one or more serial, parallel, small-computer system interface (SCSI), universal-serial bus (USB), IEEE 1394 (e.g, Firewire™), and/or personal-area network (PAN) components. The network-interface devices 510 comprise the various components used to transmit and/or receive data over a network (e g., network 204 in FIG. 2). By way of example, the network-interface devices 510 include a device that can communicate both inputs and outputs, for instance, a modulator/demodulator (e.g, modem), a wireless (e.g., radio frequency (RF)) transceiver, a telephonic interface, a bridge, a router, a network card, etc.

The memory 502 generally comprises an operating system 514 and a web browser 304. The operating system 514 controls the execution of other software and provides scheduling, input-output control, file and data management, memory management, and communication control and related services. As noted above with reference to FIGS. 3 and 4, the web browser 304 comprises software and/or firmware that is used to access various services over a network (e g., Internet) and, therefore, download content from various different sources (e.g, imaging-service web content 314, printing-service web content 318, web content 406, 410, and 416, etc.) Where the web browser 304 is configured as indicated in FIG. 3, the web browser 304 can comprise an imaging extension 310. However, it will be understood that where the system is arranged as indicated in FIG. 4, the imaging extension 310 need not be provided in the web browser 304.

The architecture of the various servers shown in FIGS. 3 and 4 are typically similar to that described above with reference to FIG. 5. Therefore, separate figures are not provided for these servers. However, persons having ordinary skill in the art will recognize that various architectures could be used to realize the servers.

The various software and/or firmware described above can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable-computer diskette, a random-access memory (RAM), a read-only memory (ROM), an erasable-programmable read-only memory (EPROM, EEPROM, or Flash memory), an optical fiber, and a portable-compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

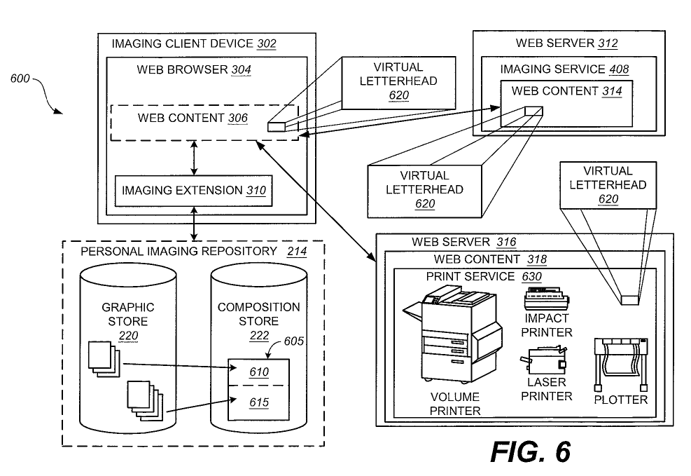

FIG. 6 is a schematic diagram illustrating an exemplar network-based imaging system. As illustrated in FIG. 6, the system 600 includes an imaging-client device 302 that is communicatively coupled to a first web server 312 and a second web server 316 via a network (not shown for simplicity of illustration). Through this coupling, web content 306 can be communicated to a web browser 304 from one or more imaging services (e.g, imaging service 408 operable on web server 312) in response to a “GET” command. The imaging-client device 302 and the web servers 312 and 316 represent any of a variety of wired and/or wireless-computing devices, as previously described.

During operation, the user can operate the web browser 304 executing on the imaging-client device 302 such that the web browser 304 interacts with numerous imaging services accessible via the network. In this example, web server 316 encompasses and provides access to a host of hard-copy generation services via print service 630. As illustrated in the schematic of FIG. 6, the remote-print service 630 may be configured to provide high-quality high-volume printing, plotting, impact printing, among other services. In addition to the above-mentioned services, the remote-print service 630 may also be configured to integrate virtual letterhead(s) 620 as a media type for appropriately configured hard-copy generation devices, as desired by users interacting with the system 600 via the imaging-client device 302.

As indicated in FIG. 6, the web browser 304 can receive imaging-service web content 314 in the form of virtual letterhead(s) 620 from web server 312. The content 314 is not actually received in the form of a letterhead; rather, the content 314 includes some or all of the data and executables that may be used to integrate a virtual-letterhead composition (i.e., a collection of images) into an existing composition 605 or alternatively, a media type within the various printing devices within the remote-print service 630. The virtual-letterhead compositions 620 may include various graphic-based images suitable for integration as a letterhead with a target image Alternatively, the virtual-letterhead composition 620 may contain references to these graphic-based images.

A target image may include documents, photographs, and/or other data in the user's personal-imaging repository 214. A target image may even include several documents, photographs, etc. Essentially, the target image can be thought of as a composition 605. Sometimes a composition will only reference a single graphic. Other times, a composition will reference several graphics. The composition 605 shown in FIG. 6 illustrates the integration of multiple graphic references 610, 615 into a single composition 605. Thus implying the integration of multiple graphics references with one or more virtual-letterhead composition images. For example, one or more virtual-letterhead compositions 620 may be integrated or associated with a particular composition 605 within the composition store 222 of the user's personal-imaging repository 214.

As shown in the schematic, the composition 605 may include a first graphic reference 610 and a second graphic reference 615. The graphic references 610, 615 refer to graphics stored in graphic store 220. Those skilled in the art will appreciate that various combinations of multiple graphics references including photographs, maps, etc. may be defined in the composition 605. Thus, the composition store 222 (a service) provides access to compositions 610, 615 (data items stored within the service). Just as a shoe store sells shoes, a composition store 222 provides access to compositions 610, 615.

As previously noted, the composition 605 may be accessed through the use of web content 306 operating within the browser 304 as described in FIG. 3, or through the use of web content 406, 410, 416 operating within the web servers 402, 312, 316 as described in FIG. 4. In the context illustrated in FIG. 3, web content 306 refers to the data that is executed by web browser 304. In the context illustrated in FIG. 4, web content 406, 410, 416 refers to the data that is executed by web servers 402, 312, and 316 respectively. Typically web content 406, 410, 416 in this context is responsible for generating web content 306 sent to the web browser 304 for execution. Typically, the composition 605 will be analyzed on the imaging-client device 302 or on the servers 312, 316 depending on where the composition 605 is accessed.

In some embodiments, the print service 630 may be a local-publishing service or office associated with the user's place of business. In these embodiments, relatively noisy impact printers, high-volume printers, plotters, and the like may be segregated from reception areas, office areas, and other areas where it may be desirable to reduce the level of background noise. A user interface responsive to logic within imaging extension 310 may include the location of the resource and the next closest alternatives (e.g., the high-volume color printer in the 12^{th} floor print center, the color laser in the 12^{th} floor print center, etc.) along with an indication of whether the resources are on-line and/or whether the resources support the addition of a virtual-letterhead composition on the associated print medium. Although depicted as a single service, it should be noted that several distinct services may exist including an imaging service (not shown) within print service 630 that may serve as a user-accessible storage facility for multiple virtual-letterhead compositions 620 that can be associated with target images or target compositions 605 in the personal-imaging repository 214.

In this way, the system 600 provides a seamless solution for associating a virtual-letterhead composition (i.e, a graphic image or graphic images) that may or may not reside on an imaging-client device 302, with a target composition 605, which may contain one or more other graphic images. Once the target composition 605 is associated with the virtual-letterhead composition 620, the web browser 304 may forward information and/or provide access to one or more remote services, such as print service 630 by way of a URL or other suitable method. Flexibility is provided because the user is able to choose among several available virtual-letterhead composition services as well as multiple destination resources. Flexibility is further provided in that appropriately configured destination resources may present an interface, which permits a user of the system 600 to apply one or more virtual-letterhead compositions 620 as a selectable media source. Just as a user of a word processing program is presented with a “printer options interface,” a network-based application can be associated with printing devices that offers a user of the system 600 the necessary flexibility to select a virtual-letterhead composition 620 as a source (much like a paper tray for a multiple-paper source capable printer) for one or more pages of the product. The network-based application provides the selected printing device with the necessary commands and links for the printing device to complete the hard-copy generation task as intended by the user.

In other embodiments, a virtual-letterhead composition 620 may be generated and stored in a user's personal-imaging repository 214. Instead of installing specific word processing, desktop publishing, and/or printer software (i e., drivers) on the imaging-client device 302, a user of the system 600 can simply use the web browser 304 to locate a network or web-based imaging service 408. Imaging service 408 may be an imaging-destination service that has the capability of adding a virtual-letterhead composition 620 (i.e., another image) to a user-identified active or default composition 605 stored in the user's personal-imaging repository 214. After locating the imaging service 408, the user may choose a particular virtual-letterhead composition 620 to incorporate into the user's default composition or selected composition. Once a virtual-letterhead composition 620 is generated containing the target composition and the virtual-letterhead template, a user of the system can direct a print job using the virtual-letterhead composition 620 to any number of different printers.

In this regard, network or web-based imaging includes provisions for forwarding a print job. For example, a first web-based imaging-destination service may be in the process of printing documents and as the service is printing a particular document some kind of failure occurs, interrupting the print job. With web-based imaging, an on-line user may be presented with the opportunity to choose a link that forwards the interrupted print job to another web-based imaging-destination service (not shown). Because both of these print services are accessing the underlying documents from the user's personal-imaging repository 214, the data being printed, and more specifically, the configuration of the data being printed does not change. Because the virtual-letterhead composition 620 (in this particular implementation) is integrated into an image composition rather than being treated as a print setting, the user does not have to manually integrate a virtual-letterhead composition 620, install drivers, etc. in order to transfer the print job to another printer. Stated another way, a redirected print job will use the same composition which still includes the virtual-letterhead composition 620. Consequently, a composition 605 including a virtual-letterhead composition 620 is free to flow to a variety of web-based imaging-destination services.

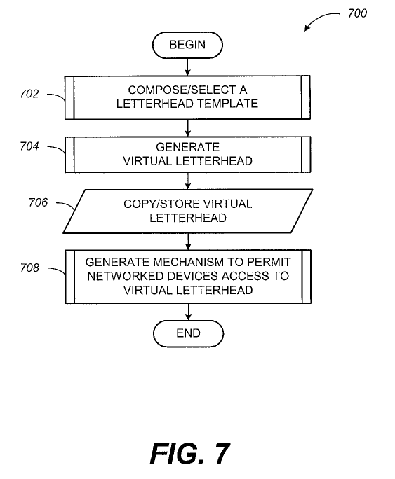

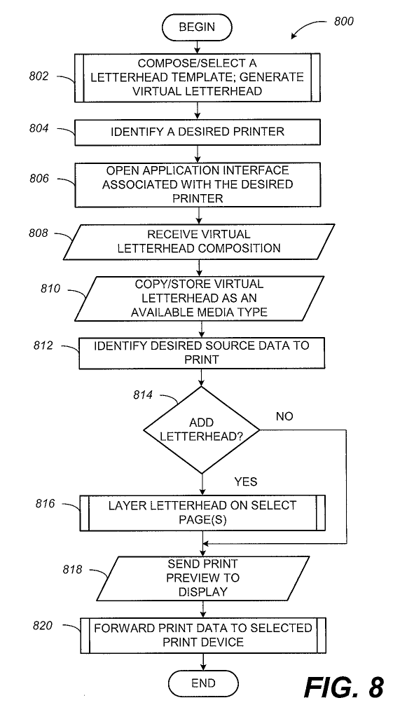

Exemplar systems having been described above, sample methods for generating a virtual letterhead and integrating virtual letterhead(s) to one or more target images will now be discussed. In this regard, the following discussions describe steps illustrated in the flowcharts of FIGS. 7 and 8. It should be understood that any process steps or blocks in these flowcharts may represent modules, segments, or portions of code that include one or more executable instructions for implementing specific logical functions or steps in the associated process. It should be appreciated that although particular process steps are described, alternative implementations are feasible. Moreover, some method steps may be executed out of order from that shown or discussed, including substantially concurrently or in reverse order, depending on the functions involved.

Reference is now directed to FIG. 7, which presents a flowchart illustrating a method for generating a virtual-letterhead composition 700 that may be used in the network-based imaging system of FIG. 6. In this regard, a user practicing the method 700 may begin by accessing an application that allows the user to compose and/or select a letterhead template as indicated in step 702. As explained above, the application may be associated with one or more available services (e.g., the remote imaging service 408 (FIG. 6)) that may be designed for generating, storing, and/or otherwise providing letterhead information to a user of the system 600 (FIG. 6). Next, as illustrated in step 704, the application software that permits a user of the system 600 to compose and/or select a letterhead template or another suitably configured application with access to the letterhead template generated in step 702 may be configured to transform the letterhead template into a virtual-letterhead composition 620 (FIG. 6).

Once the virtual-letterhead composition 620 has been generated, application software, either automatically or under the direction of a user of the system 600, may be configured to copy and/or store the virtual-letterhead composition 620 on data storage devices associated with one or more servers (e g., server 312 and/or server 316 as may be desired) and/or suitably configured image client devices 302 as illustrated in step 706. Next, as illustrated in step 708 of FIG. 7, application software operable on one or more of the servers (e.g, server 312 and/or server 316) and/or on the imaging-client device 302 may be configured to generate or otherwise enable a mechanism that permits access to network-connected computing devices to the virtual-letterhead composition 620.

It should be appreciated that method steps 702 through 708 may be repeated as desired to generate and store a virtual-letterhead composition 620. Consequently, there is no limit to the number of separate and distinct virtual-letterhead compositions 620 that may be produced, stored, and applied by the system 600. While the method for generating a virtual-letterhead composition 700 illustrated in FIG. 7 addresses the situation where a single letterhead template is transformed into an image, it should be understood that multiple letterhead templates may be identified and integrated with each other in a single virtual-letterhead composition 620 as may be desired.

Reference is now directed to FIG. 8, which presents a flowchart illustrating a method for integrating virtual letterhead(s) 800 that may be used in the network-based imaging system of FIG. 6. In this regard, a user of the system 600 (FIG. 6) practicing the method 800 may begin as illustrated in step 802 by accessing a software application configured to assist the user in composing and/or selecting previously generated letterhead information As indicated, the software application may also be configured to generate a virtual-letterhead composition 620 (FIG. 6). The software application associated with step 802 may comprise a word processor, a file manager, and a presentation interface configured to interactively modify an interface to generate -a representation of the underlying letterhead information. This letterhead information forms a letterhead template.

Once the user has generated and/or selected a previously stored letterhead template, the user may identify a desired printing device as indicated in step 804. It will be appreciated that the system 600 (FIG. 6) provides various options for the user. For example, the user may elect to generate a final product from a local printing device integrated with the client imaging device 302 (not illustrated in FIG. 6) or the user may elect to generate a final product from one or more remote printing services such as remote-print service 630 (FIG. 6). In some preferred embodiments, one or more printing devices associated with the remote-print service 630 and communicatively coupled with the user's client imaging device 302 may be provided with an interface that is both locally and remotely operable by a user of the system 600 (FIG. 6) As indicated in step 806, a printer interface may be initiated and presented to the user. As described above in association with FIG. 6, the interface may be configured with selectable options that permit a user of the system to select a particular source tray for use in generating a hard-copy product. The selected printing device and/or another device communicatively coupled with the printing device may be configured to receive one or more virtual-letterhead compositions as illustrated in step 808.

Next, as shown in step 810, the selected printing device may be directed by a user to copy and/or store one or more virtual-letterhead compositions as an available media type. It will be appreciated that this step may be accompanied by a resulting change in the printing device interface that permits a user of the system 600 to select the one or more virtual-letterhead compositions for printing on one or more pages of the hard-copy product as may be desired. It should also be appreciated that the printing device interface may be configured to permit various applications of multiple virtual-letterhead compositions across select pages of the final product. For example, a first letterhead composition may be applied to the first page of a letter while subsequent pages receive a second letterhead composition.

Once the printing device has been supplied with the desired virtual-letterhead compositions 620 and the printing device interface has been configured in accordance with the desires of the user, the user may identify a desired target image or source data image that the user desires to integrate with the selected virtual-letterhead composition(s) as indicated in step 812. After receiving the desired target image, the printing device may be configured to perform the query illustrated in step 814. When it is the case that the query of step 814 results in an affirmative response (i.e, the user has selected the appropriate check button in the printing device interface) the printer may be configured to layer and/or otherwise apply the previously identified virtual-letterhead composition on the appropriate pages as illustrated in step 816 Otherwise, when it is the case that the user has not indicated that a letterhead should be added to the hard-copy product as indicated by the negative response flow control arrow exiting the query of step 814, the printing device may skip step 816 and proceed directly to generating a print preview as shown in step 818. Because the printer has received one or more virtual-letterhead composition(s) (i e, images), the printer may integrate these images with information regarding the hard-copy medium to generate a true preview of the final product prior to applying the stored virtual letterhead and target compositions to the medium. Once the user of the system 600 (FIG. 6) is satisfied with the arrangement presented in the preview of step 818, the user may direct the printing device to perform step 820 where the underlying data information associated with the virtual-letterhead composition(s) and the target composition are forwarded to the printing device in order to generate the desired hard-copy product.

It should be appreciated that method steps 802 through 820 may be repeated as desired to generate and integrate a virtual-letterhead composition with one or more target compositions. Alternatively, method steps 804 through 820 may be repeated as desired to identify previously generated virtual-letterhead compositions designated for application (i.e., integration) with one or more target compositions in a hard-copy product. Consequently, there is no limit to the number of virtual-letterhead compositions that may be produced, stored, and applied by the system 600. While the method for integrating a virtual letterhead 800 illustrated in FIG. 8 addresses the situation where a single virtual-letterhead composition 620 is integrated with a single target composition, it should be understood that multiple virtual-letterhead compositions 620 may be integrated with a one or more target images as may be desired.

In some embodiments, the virtual letterhead image may be added to a “preferred” or “default” configuration that may include information designated to be forwarded with each print request forwarded from any node in the system 600 regarding “stores” associated with a particular user of the system. For example, a “default” configuration may include a direction to include a virtual letterhead image that includes text identifying the associated message as belonging to a particular business enterprise and/or the client addressee. Because the “default” configuration is a conglomeration of multiple images that include the virtual letterhead image, the user can initiate a print request from any node in communication with the personal-imaging repository 214 regardless of whether the communicating device understands virtual letterheads, printer drivers, and/or other applications. Moreover, the user can identify a destination service for processing the final composition without having to confirm that the destination device is configured with appropriate software and/or firmware to complete the request.

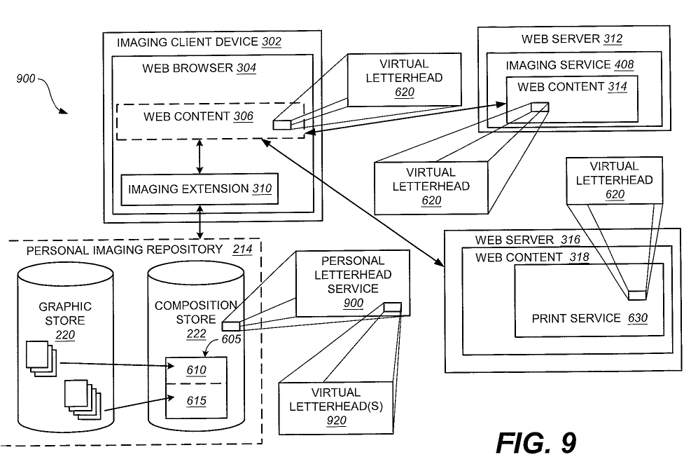

FIG. 9 is a schematic diagram illustrating an exemplar personal letterhead that may be generated, stored, and used by the network-based imaging system of FIG. 6. As illustrated in the schematic diagram of FIG. 9, a network-based imaging system 900 may include an imaging-client device 302, a personal-imaging repository 214, and a plurality of web servers 312, 316 supporting imaging service 408 and print service 630, respectively.

The network-based imaging system 900 illustrated in FIG. 9, includes an extension of the system 600 described above. In this regard, the system 900 includes a personal-letterhead service 910 that can be integrated within the personal-imaging repository 214. In operation, the personal-letterhead service 910 may provide access to a number of separate letterhead compositions from various network-coupled services. In preferred embodiments, a user's personal-imaging profile may include information identifying the personal-letterhead service 910. The personal-letterhead service 910 may include logic to manage a number of various instances of user desired letterhead images such as the virtual letterhead(s) 920.

For example, when the remote-imaging service is a print service 630, the web browser 304 may be programmed to forward data identifying a client's personal-letterhead service 910. The print service 630 maybe programmed to retrieve a list of the available (i.e., previously generated and stored) virtual-letterhead images 920 from the user's personal-imaging repository 214. The print service 630 may then integrate one or more virtual letterheads 920 into a list of available paper sources for selection by the user. Alternatively, rather than integrating one or more virtual letterheads 920 as a paper type, the print service may be programmed to manage and apply select letterhead images via any number of conceivable interfaces.

In this way, a virtual-letterhead image 920 may be accessed from the user's personal-imaging repository 214 rather than having to be uploaded to each printing device that a user may elect to use across the network This allows the user to browse around the network and instantly have available to them multiple versions of “personalized” letterhead. For example, if the user were to visit a client's office and needed to generate a hardcopy product such as a letter, the user with a suitably configured portable computing device might use a local printer on the client's office network to print the document. In this scenario, the client's print service might be directed through a web browser 304 operating on the portable computing device to access the user's personal-letterhead service 910 (which presumably could be located from the user's profile in his personal-imaging repository 214). The client's print service could, in turn, seamlessly integrate one or more selected virtual letterheads 920 into the hardcopy product generated at the client's printer.

It should be emphasized that the above-described embodiments, particularly, any “preferred” embodiments, are merely possible examples of implementations, merely set forth for a clear understanding of the principles of the systems and methods for generating and integrating virtual-letterhead compositions. Many variations and modifications may be made to the above-described embodiment(s) of the systems and methods without departing substantially from the principles thereof.

For example, a user of the system may choose an existing virtual-letterhead composition and/or create a new virtual-letterhead composition using a locally operable and/or a network-accessible application for that purpose. Regardless of the location of the letterhead generation application, the application generates a virtual-letterhead composition that defines the nature and arrangement of one or more images in relation to a selected medium (e g, a 8½×11″ sheet of paper).

By way of further example, a letterhead service, the service that adds the virtual-letterhead composition to the user's personal-imaging repository may be a destination service because it accesses imaging information or document information from the user's personal-imaging repository. The same letterhead service may also act as a source service in the sense that it adds imaging information to the user's personal-imaging repository. Stated another way, the letterhead service may be responsible for updating the user's target composition with the virtual letterhead. These and all other such modifications and variations are intended to be included herein within the scope of this disclosure and the systems and methods for generating and integrating virtual letterhead(s) using network-based imaging techniques as protected and set forth by the following claims.

Thus, having described the systems and methods for generating and integrating virtual letterhead(s), we claim the following:

1. A method for generating a virtual letterhead, comprising the steps of.
accessing a letterhead service;
selecting a letterhead template from the letterhead service; and
generating a virtual-letterhead composition comprising images reflective of underlying information associated with the letterhead template.

2. The method of claim 1, wherein the step of accessing comprises communicating with a network-connected computing device.

3. The method of claim 2, wherein the step of accessing comprises using an imaging extension.

4. The method of claim 3, wherein the imaging extension is operable in a web browser.

5. The method of claim 3, wherein the imaging extension is operable in a web server.

6. The method of claim 2, wherein the network-connected computing device is communicatively coupled with at least one data storage device containing at least one image.

7. The method of claim 1, wherein the step of selecting comprises using an application operable on the network-connected computing device to preview text information.

8. The method of claim 1, wherein the step of selecting comprises using an application operable on the network-connected computing device to preview graphics images.

9. The method of claim 1, further comprising:
storing the virtual-letterhead composition such that the virtual-letterhead composition may be accessed by a plurality of services.

10. The method of claim 9, wherein the plurality of services are operable on network-connected computing devices.

11. The method of claim 1, further comprising the step of:
presenting a visual representation of the virtual-letterhead composition.

12. The method of claim 1, further comprising:
integrating the virtual-letterhead composition with a target composition to generate a modified target composition; and
storing the modified target composition on at least one network-connected data storage device.

13. A method for integrating a virtual letterhead, comprising the steps of:
accessing a print service;
identifying a print device in communication with the print service;
receiving at least one virtual-letterhead composition from a network-connected device; and
selecting the at least one virtual-letterhead composition as a media type.

14. The method of claim 13, wherein the step of accessing comprises communicating with a network-connected computing device.

15. The method of claim 13, wherein the step of selecting comprises using an application operable on at least one network-connected computing device to configure the print device.

16. The method of claim 13, further comprising:
presenting a preview of the selected virtual-letterhead composition in register with a user selectable media type.

17. The method of claim 13, further comprising:
storing the virtual-letterhead composition such that the virtual-letterhead composition may be accessed by a plurality of services.

18. The method of claim 17, wherein the plurality of services are operable on network-connected computing devices.

19. The method of claim 17, wherein the virtual-letterhead composition is stored within a personal-letterhead service.

20. The method of claim 17, wherein the step of storing the virtual-letterhead composition comprises retaining web content such that when the web content is forwarded to a remote service, the remote service generates a hard-copy product using images identified by the virtual-letterhead composition.

21. The method of claim 19, wherein the personal-letterhead service permits an imaging service to access the virtual-letterhead composition.

22. The method of claim 13, wherein the step of accessing comprises using an imaging extension.

23. The method of claim 22, wherein the imaging extension is operable in a web browser.

24. The method of claim 22, wherein the imaging extension is operable in a web server.

25. The method of claim 13, further comprising the steps of:
receiving at least one target composition; and
presenting a visual representation of the virtual-letterhead composition in register with both a selected media type and the at least one target composition.

26. The method of claim 13, wherein the step of accessing comprises communicating with a letterhead service that is integrated with a printer service.

27. The method of claim 13, wherein the step of accessing comprises communicating with a letterhead service that is integrated with a web application source service.

28. The method of claim 13, wherein the step of accessing comprises communicating with a letterhead service that is distinct from both a printer service and a web application source service.

29. A system for adding a virtual letterhead to a document, comprising:
means for selecting at least one letterhead template;
means for transforming the at least one letterhead template into a virtual-letterhead composition;
means for identifying at least one target composition; and
means for integrating the at least one virtual-letterhead composition with the at least one target composition to generate a modified target composition.

30. The system of claim 29, wherein the means for selecting comprises an imaging-client device.

31. The system of claim 30, wherein the imaging-client device comprises a web browser.

32. The system of claim 30, wherein the web browser contains web content, the web content comprising information reflective of the virtual-letterhead composition.

33. The system of claim 30, wherein the information reflective of the virtual-letterhead composition is extracted from a network-connected imaging service computing device.

34. The system of claim 29, wherein the means for identifying at least one target composition comprises an imaging extension.

35. The system of claim 34, wherein the imaging extension communicates with a personal-imaging repository.

36. The system of claim 35, wherein the imaging extension comprises part of a web browser.

37. The system of claim 29, wherein the means for associating comprises logic in an imaging extension.

38. The system of claim 29, further comprising:
means for previewing the virtual-letterhead composition in register with the at least one target composition; and
means for transforming the previewed compositions into a hard-copy product.

39. A system for adding a virtual letterhead to a document, comprising:
a server including imaging-service content, the server coupled to a network, the imaging-service content comprising at least one virtual-letterhead composition, and
a computing device coupled to the network, the computing device configured with a browser, wherein the browser is configured to receive the imaging-service content, extract data reflective of the at least one virtual-letterhead composition designated for integration in a product with at least one target composition stored in a data storage device communicatively coupled with the computing device, and generate a modified target composition.

40. The system of claim 39, wherein the imaging-service content comprises text.

41. The system of claim 39, wherein the imaging-service content comprises a graphic design.

42. The system of claim 39, wherein the browser comprises an imaging extension.

43. The system of claim 39, further comprising:
a service server coupled to the network and a service, wherein the service server receives content from the browser.

44. The system of claim 43, wherein the content comprises resource device commands.

45. The system of claim 43, wherein the content comprises links to access the virtual-letterhead composition from the data storage device.

46. The system of claim 44, wherein the resource device commands are directed to a device configured to generate a hard-copy product.

47. The system of claim 46 wherein the device is a printing device.

48. The system of claim 47 wherein the printing device is responsive to a user adjustable interface.

49. The system of claim 39, wherein the network comprises the wide area network commonly known as the Internet.

50. The system of claim 39, wherein the network comprises a local area network.

51. A computer program embodied on a computer-readable medium, the computer program, comprising:
a code segment configured to receive imaging-service content;
a code segment configured to extract data reflective of a virtual-letterhead composition;
a code segment configured to identify at least one target composition designated for integration with the virtual-letterhead composition;
a code segment configured to generate a modified target composition comprising the virtual-letterhead composition and the at least one target composition, and
a code segment configured to store the virtual-letterhead composition as a media type.

52. The program of claim 51, further comprising:
a code segment configured to forward the modified target composition to at least one service to generate a product.

53. The program of claim 51, wherein the code segment configured to receive is operable on an imaging-client device.

54. The program of claim 51, wherein the code segment configured to extract is operative with a web browser.

55. The program of claim 51, wherein the code segment configured to identify comprises an imaging extension operative with a web browser, wherein the imaging extension communicates with a data storage device.

56. The program of claim 51, wherein the code segment configured to generate overwrites the target composition on a data storage device.

57. The program of claim 51, wherein the code segment configured to generate saves the modified target composition and retains the target composition.

58. The program of claim 52, wherein the at least one service is a print service.

59. The program of claim 58, wherein the print service receives the forwarded content, the forwarded content comprising a link to the virtual-letterhead composition, the virtual-letterhead composition residing within a personal-imaging repository.
